(19) United States
(12) Patent Application Publication
(10) Pub. No.: US 2025/0269211 A1
(43) Pub. Date: Aug. 28, 2025

(54) PERSONAL PROTECTIVE DEVICE AND METHODS OF MANUFACTURE THEREOF

(71) Applicants: Nelson L. JUMBE, Mountain View, CA (US); Andreas SCHUH, Millbrae, CA (US); Peter REXELIUS, San Francisco, CA (US); Michael MORIMOTO, Dublin, CA (US); Andrew URAZAKI, Duarte, CA (US); Steve KRAWCZYK, Mountain View, CA (US)

(72) Inventors: Nelson L. JUMBE, Mountain View, CA (US); Andreas SCHUH, Millbrae, CA (US); Peter REXELIUS, San Francisco, CA (US); Michael MORIMOTO, Dublin, CA (US); Andrew URAZAKI, Duarte, CA (US); Steve KRAWCZYK, Mountain View, CA (US)

(21) Appl. No.: 18/256,985

(22) PCT Filed: Dec. 13, 2021
(86) PCT No.: PCT/US2021/063152

§ 371 Date: Jun. 12, 2023

Related U.S. Application Data
(60) Provisional application No. 63/124,632, filed on Dec. 11, 2020.

(51) Int. Cl. A62B 18/02; A62B 9/00

(52) U.S. Cl. CPC A62B 18/025; A62B 9/006

(57) ABSTRACT

The present disclosure provides embodiments of a personal protective device which include one or more sensors. The personal protective device is in the form factor of a filtered mask to cover the nose and the mouth of the subject when in use. One or more sensor modules are connected to the mask for detecting one or more parameters related to an inhalation and or exhalation of the subject. The mask is held onto the face of the subject by one or more support members.

### CROSS-REFERENCE TO RELATED APPLICATION

This application is a National Phase Entry of international PCT patent application No. PCT/US2021/063152 filed on Dec. 13, 2021, which claims the benefit of U.S. Provisional Patent Application No. 63/124,632, filed on Dec. 11, 2020, the contents of which are incorporated by reference herein in their entirety.

### BACKGROUND

Concerns about the secondary ramifications of the pandemic have focused nearly exclusively on a global economic recession. There should be similar concerns of a social isolation, loneliness and mental health recession. Similar to an economic recession that can have lasting effects even after the economy begins to grow, the social restrictions put in place during the pandemic may have profound long-term consequences, even after restrictions are lifted.

The COVID-19 pandemic has led to implementation of unprecedented “social distancing” strategies crucial to limiting the spread of the virus. In addition to quarantine and isolation procedures for those who have been exposed to or infected with COVID-19, social distancing has been enforced amongst the general population to reduce the transmission of COVID-19. The COVID-19 pandemic and the need to slow the virus' spread have highlighted the pervasiveness of social contact within, and social relevance of, nearly every sector of our lives, including employment, education, entertainment, travel, transportation, and recreation. The pandemic has also highlighted the underlying weaknesses of the current social “support systems” for older adults, students, families, workers, and at-risk populations. Use of face masks at the community level may safeguard better physical and mental health during the COVID-19 pandemic. However, the idea and communal pressure to have to wear a mask all day can certainly be anxiety-provoking. If a person is prone to have an anxiety or a panic kind of disorder, or sometimes they find it difficult to catch their breath as part of their anxiety, masks can also certainly contribute to and be anxiety provoking. Covering the mouth and nose can cause anxiety prone individuals to feel trapped and/or claustrophobic. Current masks are either based on existing design available to the public since before the pandemic (such as masks certified as N95 or N99) or hastily put together using substandard materials such as regular garment that offers little filtering and hence minimum protection. Surgical masks are designed to preferentially protect others from your own breath and offer minimum safety towards inhalation of contaminants. Although masks with N95/99 certification offer good protection against outside particles they are inconvenient to use as the filter restricts the air flow significantly during inhalation and exhalation. During Inhalation that puts greater effort onto the lungs to expand the muscles. During exhalation often times the path of lower air resistance is at the interface between mask and face skin, meaning part of the air bypasses the filter entirely and hence exposes others to one's breath contaminants. This also means that air escaping through a gap around the nose causes fogging of people wearing glasses due to the humidity of the air. This can trigger undesired actions, for example the person starting to fiddle with the mask, pulling down the mask to remedy the issue or adjusting the position of the glasses, all with potentially contaminated fingers. To mitigate the resistance to exhalation, some existing mask designs incorporate one-way valves to reduce the resistance to exhalation. Unless specially filtered, not only do these offer no protection to others around the wearer, but may exacerbate infection risk by projecting a concentrated jet of potentially contaminated breath towards others, and in the case of food preparation workers, toward food products that they are handling.

### Limitations of Current Personal Protective Equipment and Effect on Social Interactions and Considerations Thereof

Under ordinary circumstances, where individuals have control over the number and quality of their interactions, the costs of perceived social isolation are already high. As studies have repeatedly documented, social isolation contributes to elevated blood pressure, morning spikes in cortisol levels, and disrupted sleep.² Furthermore, experiments mimicking social isolation contributed to significant declines in cognitive performance and increases in cognitive impairments in undergraduate students, even during a single brief course-related study.³ Perceived social isolation or loneliness is a better predictor of mortality after heart attack than other cardiovascular risk factors.⁴ Moreover, healthy students during a brief summer vacation showed slower rates of wound healing than their less isolated peers.⁵

There is collateral high cost associated with the essential quarantine and social distancing interventions for COVID-19, especially in older adults, who have experienced an acute, severe sense of social isolation and loneliness with potentially serious mental and physical health consequences. The impact may be disproportionately amplified in those with pre-existing mental illness, who are often suffering from loneliness and social isolation prior to the enhanced distancing from others imposed by the COVID-19 pandemic public health measures. Earlier quarantines give us some indications of the potential fallout from extended periods of isolation. After being quarantined during the epidemic of sudden acute respiratory syndrome (SARS), individuals who were quarantined or had relatives who contracted SARS were 2 to 3 times more likely to report high levels of posttraumatic stress disorder (PTSD) symptoms than the rest of the population.

While social isolation and loneliness were prevalent in the population prior to COVID-19, efforts to reduce the virus' spread via stay-at-home orders, quarantine, and social distancing recommendations have exacerbated an already serious problem. With the exception of “essential workers,” the pandemic has meant limiting physical proximity to those with whom one lives. For the 28 percent of Americans who live alone, this has meant little to no human contact for months. Regardless of living situation, interactions with anyone outside the home have been severely limited for everyone. Preliminary surveys suggest that within the first month of COVID-19, loneliness increased by 20 to 30 percent, and emotional distress tripled. While several surveys are still ongoing to capture the full extent of the problem, current evidence suggests the pre-existing public health crisis of social isolation and loneliness may be far more widespread than previously estimated.

In addition, older adults, people of color, those with low income, and those in congregate living centers (e.g., nursing homes and prisons) have been disproportionately victims of COVID-19. These populations were already at high risk for poor health outcomes, social isolation, and loneliness. Pandemic-related inequities in access to resources compound this risk. For example, the prevalence of loneliness is higher among low-income individuals, who may be less able to work remotely and subsequently more likely to lose employment.

Older adults are also more vulnerable to social isolation and loneliness as they are functionally very dependent on family members or supports by community services. While robust social restrictions are necessary to prevent spread of COVID-19, the side effect of social distancing has unfortunately transitioned to equating to social disconnection. The risk of COVID-19 infection is greater for older adults over the age of 60 years who are at a heightened risk of severe illness, hospitalization, intensive care unit admission, and death (US CDC, 2020). According to the Centre for Evidence-Based Medicine, the case fatality rate (CFR) is about 4% for patients over 60 years old, 8% for patients over age 70 years, and approximately 15% for patients over the age of 80 (Oxford COVID-19 Evidence Service, 2020). This compares with CFR of 0.0026%-0.3% in those under age 45.

Nearly half of all adults in the U.S. have reported their mental health has suffered due to the pandemic, according to a recent poll. Measures in place to protect public health like closing schools, limited staffing, business closures and social distancing unfortunately have led to greater isolation and loneliness—which is linked to poor mental health outcomes.

Maintaining connections to others outside the home during the quarantine has increased our reliance upon phones and digital technologies. Of course, reliance on technology was rapidly increasing prior to the pandemic, but with increasing demand for telehealth, telework, and online education, issues of connectivity and the digital divide have been catapulted to the forefront of many policy discussions. Access to the internet is more crucial than ever, but we must pause to ask the bigger question: what is the full scope of consequences that may result from scaling digital capabilities and solutions?

Social isolation affects everyone in different ways. Effects can range from mild to a high risk for suicide. Below are specific summaries in which isolation could be particularly harmful to a specific individual's mental health:
Behavioral or Developmental Disorders: People who have impairments with learning, language, physical movement or behavior may have difficulties accessing information, taking preventative measures against the pandemic or communicating their own symptoms if they are sick. They're also more at risk for anxiety and depression, which could be exacerbated by being isolated from others.
Caregivers: Caring for an older parent or sick child can be especially isolating during the pandemic. Keeping the household safe from exposure to COVID-19 may mean caregivers are taking on more tasks themselves instead of finding relief from outside help.
Children: With the school year disrupted by the pandemic, many children may be missing the social interaction that comes from sports, activities and daily classes. Adolescent children who are already more at risk for depression may experience greater reactions to their new social limits and act out at home.
Grieving a Loss: Losing a family member or friend is difficult regardless of the circumstances, but the pandemic makes grieving even more difficult with restrictions on travel and large gatherings. Many severely ill COVID-19 patients are unable to have loved ones at their side due to hospital visitor restrictions. Not being able to say goodbye or fully grieve the loss of someone can be traumatic.
History of Depression or Anxiety: People who have a history of depression and anxiety diagnoses are at a higher risk for negative effects from isolation during the pandemic.
Seniors: Adults age 65 and over are at a high risk of severe illness from COVID-19, so many must take extra precautions to distance themselves from others during the pandemic. With a higher risk for depression and without in-person support from friends and family, seniors may be particularly isolated.
Employees: Reduced engagement, lower productivity, lower quality of work, Zoom fatigue, reduced personal care, greater workplace absenteeism, surges in mental health concerns, substance abuse, domestic violence, poorer sleep, and emotional or overeating, etc.

### Effect on Wearing Conventional Personal Protective Gear on Beauty Trends

Life in lockdown and an abrupt switch to working from home has prompted many women to abandon their usual beauty routines—causing a big shock for the $530 billion cosmetics industry. As a result, this recession is expected to be unlike any other for the beauty sector.

The “lipstick index” coined just after the September 11 attacks by Leonard Lauder, chairman emeritus of the international cosmetics company Estée Lauder—backed up, reportedly, by the company's own lipstick sales—is that in times of economic uncertainty, affordable luxuries like a striking lipstick shade help prop up select retailers even through downturns. In a financial crisis, the theory goes, people cut back on gym memberships, eating out, and holidays. But on a bad day (and during a financial crisis, those bad days are legion), a consumer will still reliably reach for retail therapy: picking up a cupcake, a magazine, or, famously, a tube of lipstick.

A pandemic requiring protracted mask wearing is quite different. After all, why wear lipstick or other cosmetics that are not visible when wearing a mask. Mckinsey estimates that global beauty sales could fall by 20% to 30% in 2020. Lipstick in particular is taking a major hit. Amazon sales in the U.S. tracked by Mckinsey show “lip care and color” taking the steepest decline in retail sales of any segment, with sales falling 15% and prices falling 28%.

Meanwhile, cosmetics for areas still visible when wearing personal protective gear has either remained high or increased. For example, hair coloring product sales, likely spurred by salon closures, spiked by 172%.

Nail care products, meanwhile, rose the most of any product area, by 218%, a trend that was also reported at European e-retailers. These data play directly into a hypothesis that attributes the lipstick effect to evolutionary psychology—whereby economic recessions influence men's and women's desire for beauty products are an insight into mating psychology, consumer behavior, and the relationship between the two. Spending on beauty products may be the third indicator of economic recessions—an indicator that may be rooted in our ancestral psychology.

Various signs of mental health distress is also not visible when interacting while wearing a mask. Social queues and expressions such as anger, happiness, uneasiness, etc. Wearing a mask hides the majority of these signs further exacerbating risk to the individual. Health concerns stemming from social deprivation include high blood pressure, sleeplessness or less restful sleep, anxiety, depression, and thoughts of suicide. In addition, lack of human interaction may increase hormone levels that contribute to inflammation and weakened immunity, thereby increasing the risk of diseases.

It is therefore desired to provide an update to personal protective devices to adapt to the needs of individuals not only on a functional basis, but to integrate personalized health evaluation and recording as well as societal interaction needs, group monitoring and group detection needs. All of the advancements will not only help end the pandemic, but will also act as an integral system of early detection and response to future pandemics.

Additional reasons why the devices, methods and systems of the present technology are advances over existing mask technologies include the ability to communicate through enablement of facial expressions, increase in self-esteem through the use of makeup, better aesthetics, eco-friendliness, fog-resistant, ease of breathing, increased comfort, enable normal conversation, allow for ease of exercise, ease of eating or drinking while maintaining protection for the wearer and others around them. These technologies help prevent individuals from being dissuaded from using masks due to limitation to express themselves and interact with others.

Further, integration and implementation of compact non-invasive diagnostic tools allow for additional functional usage that would help persuade individuals to wear masks.

### BRIEF SUMMARY OF THE TECHNOLOGY

According to certain aspects, there are provided devices, methods and systems for personal protection. In certain embodiments, present devices are configured as a mask which may have modular components for various use cases. In certain embodiments, present devices, methods and systems provide for advancing various use cases such as disease screening, diagnostics, and/or prognostics.

### Aesthetics: Benefits of a Clear View of the Face

Clear filaments are no longer uncommon for 3D printing. Most of the clear filaments available today are made from PLA, but there are also several options made from PETG or ABS. Not all plastics are naturally clear. The quality of clear filaments differs greatly between different brands. Depending on the brand and how the filament was made, some clear filaments may turn out to be slightly translucent or have a minor yellow hue. ABS, in particular, is a naturally yellowish-white plastic that requires additives to achieve a clear appearance. Some filament have air bubbles, which can easily cause heavy light diffraction and make it impossible to achieve a perfectly clear appearance.

Selection of transparent axis. It is important to decide on which axes you need the object to be transparent, sides (x and y axes) or from the top (z-axis). Achieving transparency in the z-axis is much simpler and decidedly more complicated in the x-axis and y-axis. For the mask, personalized transparency across the three axes is an intentional design objective. This design goal is further augmented by reducing diffraction and internal reflection, by giving light rays wider paths to transmit through and reflect in predictable directions. This is achieved by setting layer heights at up to 90% of the nozzle diameter. The rationale behind this is that thicker and more spherical layers reduce internal reflection by providing the rays of light thicker segments of material where they can pass through unimpeded. When using thin layers, they should be fused to make a more solid block of plastic, to avoid layer boundaries that can act as impurities in the inner surface of the finished print, thus causing diffraction and refraction. Printing with thick layers also forces the material closer together than normal, making them less likely to form distinct layer boundaries. This means setting requires printing temperature at or above the highest value of the recommended temperature range to create a single, solid block of material instead of one with clearly demarcated layers. Alternatively, and for a different effect, one could print slow—about 30% slower than the normal printing speed for the filament. This helps with accuracy, ensuring that layers are laid down exactly where they need to be to achieve complete fusing. By printing slow, the inclusion of air bubbles is reduced.

To reduce shift in the material from causing internal reflections or refraction, 100% infill is required to avoid light bending when transitioning from plastic to air.

Printing with thick layers results in prints with very rough outside surfaces and uneven surfaces cause the reflection of light in different directions, creating a non-transparent look. This is a problem that can be resolved with proper smoothing and polishing techniques.

By subjecting an ABS print to a bath of acetone vapors, a very thin layer of ABS can be selectively dissolved to create a perfectly smooth finish. In most cases, this is enough to achieve a perfectly transparent look with ABS. Finishing a PLA print will take a lot more time and effort. Smoothing PLA relies on abrasive polishing, which has to be done at a high refinement degree to achieve transparency. This means using several types of sandpaper, from low-grit to high-grit (4000-grit). PETG is the kind of filament that does not need a lot of post-processing. PETG is a filament material that is pre-disposed to create prints with clear and smooth surfaces. It also has excellent layer adhesion.

Alternatively, the Polysmooth filament expressly designed for transparent 3D printing can be used. Polysmooth has the same ease of use as PLA, has excellent layer adhesion, and has a wide printing temperature range. It comes in a wide range of colors, many of which are designed to be as clear and transparent as possible. Furthermore, Polysmooth is soluble in isopropyl alcohol or ethanol. This presents the possibility of smoothing via a vapor bath.

Masks 3D printed from Polysmooth are placed in the Polysher, a specially designed polishing chamber that comes with a small reservoir where you can place the alcohol. Instead of heating the alcohol, the alcohol is nebulized in the chamber or sprayed in a very fine mist. This alcohol aerosol dissolves a very thin layer of the Polysmooth material, creating a perfectly smooth finish with minimal effort.

### Mask Aesthetics to Enable “Warm” Distancing

With so many services already migrating to a telemedicine model during the pandemic, video conferencing is clearly a timely, safe, and apt solution to mitigate the social isolation, fear, and exacerbation of emerging and existing psychiatric conditions. While digital tools have clear benefits, including the capability to provide access to information and resources and bridge distances, there are potential tradeoffs. Digital tools approximate but do not satisfy the human experience of in-person contact, nor the biological needs for human connection. There is some evidence of a “loneliness paradox” wherein tech and social media that should make us more socially connected actually increase loneliness. In addition, the pandemic has highlighted limitations of video conferencing tools that go beyond Zoom Fatigue. For example, anyone who has attended a virtual funeral or wedding, or even just a virtual happy hour, realizes that it may be better than nothing but feels drastically inadequate.

In embodiments of the “warm”-distancing facepiece covering addresses the issue many people have that expressiveness and day-to-day communication are reduced when half of the face is covered and create a “warm” distance for necessary service providers required to attend work in person and also use digital services.

The warm distancing face cover material can optionally be turned into a non-transparent material whenever it is desired depending on situation. This can be accomplished through the use photo sensitive covers and/or polymer dispersed liquid crystal technology (PDLC) and an electronic control circuit.

### Eye Cover

Emerging studies suggest that the proportion infected of the patients who reported routinely wearing eyeglasses more than 8 hours per day was lower than in the general population. These data suggest that wearing eyeglasses more than 8 hours per day may be protective against SARS-COV-2 infection. The underlying hypothesis is that this may be due to eyeglasses acting as a barrier that reduces the frequency with which people touch their eyes.

Our transparent “warm”-distancing facepiece covers the eyes and ear plugs for maximum protection.

The present technology facepiece is a respiratory protective device designed to achieve a very close facial fit and very efficient filtration of airborne particles. The edges of the facepiece are designed to form a seal around the eyes, nose and mouth.

In one aspect, an interchangeable and customer personalized face conforming adapter may be attached to the inner surface of the mask. The fit of this adaptor on a subject's face is shown in FIG. 8, allowing the mask to be provided with a variety of different adapters for different sizes and shapes of faces (e.g., small, medium, large, round, or angular faces). In another aspect, the adaptor may have an embedded flexible shape memory element made of metal or deformable polymer, or an articulated mechanical armature to allow a custom fit to the subject's face. In some respects, the adaptor may be thermoformable, so a custom fit may be achieved by warming the adaptor, fitting it on the subject's face, then allowing it to cool. In some instances, a mold of the subject's face may be made using silicone molding material, or for example, crushable foam, and the adaptor may be made from that mold by the retailer, distributor, or manufacturer.

In some aspects, the mask may be modular and comprise separate mouthpieces, nose pieces and eyepieces, headbands, earloops or temple pieces which may be assembled through the use of Velcro, magnetic fasteners, bayonets, snap connectors, repositionable adhesives or other suitable means.

Our “warm”-distancing facepiece is tested for fluid resistance, filtration efficiency (particulate filtration efficiency and bacterial filtration efficiency), flammability and biocompatibility and covers the following range of formation:
N95, N99, N100—Filters at least 95%, 99%, 99.97% of airborne particles. Not resistant to oil.
R95, R99, R100—Filters at least 95%, 99%, 99.97% of airborne particles. Somewhat resistant to oil.
P95, P99, P100—Filters at least 95%, 99%, 99.97% of airborne particles. Strongly resistant to oil.
The “warm”-distancing facepiece is available in multiple skin tone colors and can be personalized
The “warm”-distancing facepiece should not be shared or reused.

### Air Filtering and Assisted Air Flow to Maintain Respiratory Function and Levels

Following the common refrain over the course of the pandemic: “My mask protects you, your mask protects me.” Masks help keep viral particles in—an important measure for a disease that is spread by people who aren't showing symptoms. In addition to stopping respiratory droplets—which are thought to be the main way the virus spreads—on their way out of the wearer's mouth and nose, “masks also help reduce inhalation of these droplets by the wearer”. This means masks can help stop the spread in two ways: “Source control,” or preventing infected people from spreading the virus, and “personal protection,” or helping healthy people stay healthy. Therefore, the goal of a high performant mask is to filter the air on the way in and the way out; may be even more on the way out as to protect others. The dual benefit adds another incentive to follow mask-wearing guidance as “individual benefit increases with increasing community mask use”—or the more, the merrier when it comes to covering up.

Additionally, poor atmospheric air quality can lead to decreased cognitive function resulting in significant impacts on productivity, learning, and safety. Recent studies have demonstrated clear negative effects of elevated VOC levels on cognitive abilities such as strategic thinking and decision making.

Thus, the current technology provides for personal protective equipment (PPE) masks that encourage use by addressing the major shortcomings of existing protective face covering by providing for a facepiece that is built out of bespoke porous clear metamaterial with two-way filtering and one or more dual-direction fans creating a positive pressure inside the mask by pushing air in through filters.

In some embodiments, the devices, methods and systems of the present technology provide fresh air and slight positive pressure inside the masque by, for example, including at least one fan on each side of the mask. One solution is to have one counterfactual/asymmetric fan coupling-one fan sucks in air from outside into the masque, and the same mechanism used to “pull” in air is used to “push” the other fan in the opposite direction to exhaust the air back out. The fans are coupled or decoupled depending on health and activity state of the individual. Fans can adaptively be controlled based on time within the respiration cycle to optimize air exchange and keep it the minimum possible level. Each fan may be equipped with a N100 filter that is changeable. In another embodiment, the mask can comprise one or two fans pushing in air into the masque with accompanying filters, and the air outlet is simply another filter without a fan on the side of the mask. In a fanless embodiment, openings with filters are located on the side of the mask.

These design features achieve the following conditions:
slight positive pressure inside the mask such that contaminated air is not slipping into the masque between the skin/masque interface.
adaptive fan speed (can be based on air pressure inside the mask) to save battery and not pull in unnecessary potentially contaminated air from outside particularly between breathing cycles.
any location of air exchange with outside needs filters

Furthermore, the devices, methods and systems of the present technology may comprise an optional essential oil evaporator that can be inserted to make it smell like gum, lavender, eucalyptus or other organoleptically pleasant or medically therapeutic scent to help people to either calm down (reduce breathing frequency) or help someone having trouble breathing due to some other lung conditions. In some embodiments, the scent is only emitted during exhalation to scent the air around the wearer. Alternatively, the evaporator is filled with sterile and a miniaturized servomechanism and exhaled breath controlled heater maintains temperature in order to deliver sedatives safely, while avoiding hazards, such as overheating, condensation, changes in the compressible volume of the circuit, leaks in the tubing, and obstruction often encountered with traditional ventilation systems.

In some embodiments, the devices, methods and systems of the present technology may comprise an optional opening for cigarette smokers, straws, or external ventilator attachments.

Hypoxia is a condition in which the body is deprived of adequate oxygen supply at the tissue level. It can occur quickly, and the body's ability to adapt to a low-oxygen condition is poor when the onset is fast. A gradient of hypoxic state is experienced often within a few minutes if the ppO₂ in the individuals air supply drops even insignificantly. Acute hypoxia is characterized by impaired cognitive performance and sometimes leads to loss of consciousness. Very few people have summited Mt. Everest without supplementary O₂, but the feat alone provides evidence that each individual is affected by hypoxia quite differently. This is particularly true for individuals with underlying heart failure, high blood pressure, bronchospasms, asthma, COPD, cystic fibrosis, exercising, etc.

Capnography—Capnography is used in a wide range of medical applications to obtain critical information about the patient's health. This can include respiration rate, CO₂ excretion, pulmonary perfusion, alveolar ventilation, respiratory patterns, and measurement of the elimination of CO₂ from the anesthesia breathing circuit and ventilator.

Capnography measures the partial pressure of carbon dioxide in exhaled breath (PeCO₂) as a function of time or exhaled volume. The resulting waveform, or capnogram, provides a graphic representation of PeCO₂ as a function of time. Capnographs display a numerical value as well a waveform, which is a graphical depiction of the PeCO₂ concentration in each exhaled breath. Capnography is an essential element of modern anesthesia and respiratory care. End-tidal capnography (EtCO₂) is the measurement of the maximum concentration of carbon dioxide (CO₂) in exhaled breath.

In the privacy, health, safety and security mask, the exhaled breath travels via a specific path through and out of the individual's mask. In one embodiment, a CO₂ sensor, using but not limited to non-dispersive infrared (NDIR), and working on the principle that CO₂ absorbs infrared radiation (IR) is established in the exhalation pathway. The proprietary LED is optimally tuned with 4.3 μm LEDs (FIGS. 4 & 5) for NDIR which rejects all signals except CO₂ and/or N₂O.

The presence of CO₂ in the gas leads to a reduction in the amount of light falling on the sensor, which changes the voltage in a circuit. The output voltage reveals the individual's PeCO₂. The capnogram shape itself has diagnostic value, when analyzed objectively and quantitatively. Embedded edge inference quantitative methods tuned to automated real-time capnogram analysis are applied to distinguish between normal and hypoxic states optimized for the individual. The personalized algorithms are initially trained on available biometric data. The analysis is rapid and accurate and is indicative of current health status and predictive of future functional health state.

By comparing incurrent and excurrent CO₂ and/or N₂O. gas concentrations, and thus measuring the reduction in oxygen concentration and increase in CO₂ concentration, it is possible to derive accurate measurements of the individual's O₂ consumption rate (VO₂) and CO₂ production rate (VCO₂), from which its respiratory quotient (RQ=VCO₂/VO₂) and Energy Expenditure (EE) can be calculated.

### Additional Breath Analysis Metrics

Breath may be further analyzed to indicate further characteristics of an individual. Inspired air may provide the following metrics: Flow rate, pressure, ppO₂, ppCO₂, Temperature, Humidity, Particulate (PM2.5) and tVOC (total volatile organic compounds). Exhaled air may provide the following metrics: PeO₂, PeCO₂, FiO₂ (fraction of inspired oxygen), ketones, hydration, and volatile organic compounds. Combinations of breath analysis, especially overtime as found with longitudinal data may be used as early indicators and possibly for diagnosing certain diseases.

In addition to breath, additional individual indicators may be monitored including: ECG, Vibroacoustics, PPG, galvanic skin response, hydration state, body fat content, BMI respiration rate, core body temperature. Furthermore, environmental determinants of health may be monitored including: 9 degrees-of-freedom interial measurement unit (IMU), temperature, humidity, barometric pressure, tVOC (air quality), light exposure, noise exposure.

Derived metrics—Heart rate (HR), heart rate variability (HRV), respiration rate (RR), SpO₂, etCO₂, VO₂, VCO₂, respiratory quotient (RQ), and energy expenditure (EE), etc

The mask may be a microprocessor powered connected device. The slight positive pressure is maintained to always ensure no penetration of contaminated air through gaps between mask and skin is possible. In addition, the speed of the fan(s) is adaptive depending on the depth of inhaling/exhaling and the point in time during those. Air quality sensors ensure that sufficient fresh air is supplied through the mask itself with the fans able to help in case of need.

In an alternative design, the mask is created by a non-filtering and airtight material, with at least two openings mounted with filters and fans. The fans work in a push-pull fashion, meaning air is pushed into the mask on one side and pulled out through the other side while maintaining positive air pressure inside (like airflow in high performance computers). The adaptive fan technology allows positive pressure and sufficient fresh air supply during inhaling as well as pulling out sufficient ‘used’ air during exhaling.

A sufficient external power source connector and/or battery is incorporated into the design together with a communication model (Bluetooth, Wi-Fi) to inform the user of system statuses and air exchange quality; and a variety of other sensors including temperature, humidity, air pressure.

The potential power supplies for the devices, methods and systems of the present technology may comprise typical rechargeable and non-rechargeable chemical cell and battery systems such, but not limited to, lithium-based systems, including, but not limited to lithium polymer, lithium phosphate, solid state lithium, lithium iron phosphate, lithium manganese oxide, lithium cobalt oxide, lithium titanate, lithium nickel cobalt aluminum oxide or lithium nickel manganese cobalt oxide. Other exemplary cell or battery types that may be used include, but are not limited to zinc-air, carbon-zinc, alkaline, or silver oxide. In some embodiments, ambient energy harvesting may be employed either as the sole power source, or as a power supply to charge the internal battery. In some embodiments, super capacitors may be used alone, or in combination with ambient energy harvesting and/or chemical cell and battery systems.

Exemplary ambient energy harvesting systems may include, but are not limited to fluid flow, photovoltaic, ambient radiation, piezoelectric, pyroelectric, thermoelectric, electrostatic, magnetic induction, metamaterial, atmospheric pressure changes and other mechanical motion energy capture such as from arm or leg.

### Communication Module Integration for Individual and Group Health Monitoring

The proposed mask is an automated system which is capable of monitoring and timely alerting to individuals regarding potential privacy, health, safety and security concerns with their physiological health state in any setting. In certain embodiments, the mask acts as a self-alerting processor of the individuals' physiological health status and provides state data as well an inertial measurement units (IMU), social and environmental health data and inhaled air atmospherics data.

The small form factor computing hardware proposed in various embodiments for the privacy, health, safety and security mask is self-contained and self-powered, and is small and lightweight enough to easily integrate into the smart wearable device.

A communication module may be configured to communicate sensor data, analysis data, and/or other information to an external computing device. Additionally, or alternatively, the communication module may communicate with external sources for microcontroller programming and software updates. The external computing device may be, for example, a mobile computing device (e.g., mobile telephone, tablet, smart watch), laptop, desktop, medical equipment, or other suitable computing device. The external computing device may be executing an application for presenting sensor data (and/or the results of analysis thereof) through a user interface to a user.

Additionally, or alternatively, the communication module may be configured to communicate data to one or more networked devices, such as a hub paired with the system, a server, a cloud network, etc. In some variations, the communication module may be configured to communicate information in an encrypted manner. While in some variations the communication module 2340 may be separate from the processor(s) as a separate device, in variations at least a portion of the communication module may be integrated with the processor (e.g., the processor may include encryption hardware, such as advanced encryption standard (AES) hardware accelerator (e.g., 128/256-bit key) or HASH (e.g., SHA-256)). Additional aspects of the communication scheme are described in further detail below with respect to the signal processing system.

The communication module may communicate via a wired connection (e.g., including a physical connection such as a cable with a suitable connection interface such as USB, mini-USB, etc.) and/or a wireless network (e.g., through NFC, Bluetooth, WiFi, RFID, or any type of digital network that is not connected by cables). For example, devices may directly communicate with each other in pairwise connection (1:1 relationship), or in a hub-spoke or broadcasting connection (“one to many” or 1:m relationship). As another example, the devices may communicate with each other through mesh networking connections (e.g., “many to many”, or m:m relationships), such as through Bluetooth mesh networking. Wireless communication may use any of a plurality of communication standards, protocols, and technologies, including but not limited to, Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (WiFi) (e.g., IEEE 802.11a, IEEE 802.11b, IEEE 802.11g, IEEE 802.11n, and the like), or any other suitable communication protocol. Some wireless network deployments may combine networks from multiple cellular networks (e.g., 3G, 4G, 5G) and/or use a mix of cellular, WiFi, and satellite communication.

In some variations, the communication module (e.g., used as input and function manipulation, and/or tactile feedback) may include multiple data communication streams or channels to help ensure broad spectrum data transfer (e.g., Opus 20 kHz with minimal delay codec). Such multiple data communication streams are an improvement over typical wireless data transmission codecs. For example, most wireless data transmission codecs (e.g., G.711) use a bandpass filter to only encode the optimal range of human speech, 300 Hz to 3,400 Hz (this is commonly referred to as a narrowband codec). As another example, some wireless data transmission codecs (e.g., G.722) encodes the range from 300 Hz to 7,000 Hz (this is commonly referred to as a wideband codec). However, most of the energy is concentrated below 1,000 Hz and there is virtually no audible sound above 5,000 Hz, while there is a measurable amount of energy above the 3,400 Hz cutoff of most codecs. The data throughput requirements for both G.711 and G.722 are the same because the modulation used in G.722 is a modified version of the PCM called Adaptive Differential Pulse Code Modulation (ADPCM). When this kind of complexity is added to a codec and process power remains constant, this will add latency. As such, G.711 will introduce latency well below just one millisecond but G.722 could introduce tens of milliseconds of delay-which is an unacceptably long delay in vibroacoustics.

In contrast, in one embodiment, the devices, methods and systems of the present technology provide for sensor configurations that incorporate environmental and other physiological or physical data to greatly improve both the sensitivity and specificity of the physiological or physical state of the subject. As a non-limiting example, when the environmental sensor detects a chemical that is metabolized by a healthy subject to an exhaled compound that would otherwise be a signal suggesting a subject's abnormal physiological state, the system would be able to recognize that signal as a false positive. In a similar manner, the environmental sensors could detect the difference between ambient and subject temperature, and account for expected changes in the exhaled chemical profile. Another non-limiting example is the ability of the devices, methods and systems of the present technology to differentiate between scleral injection caused by fatigue, sleep deficit, mechanical conjunctival irritation, chemical conjunctival irritation, recent cannabis use, or pink eye.

In one embodiment, the devices, methods and systems of the present technology provide for the ability, when deployed in a mesh configuration with a plurality of subjects, to detect the onset of the “mass contagion” effect” caused by foul or unusual odors or other environmental or psychological stimuli.

In another embodiment, the devices, methods and systems of the present technology provide for environmental surveillance capabilities for monitoring solvent exposure to hazards such as, but not limited to benzene, toluene, methyl chloride, hydrogen sulfide, aerosols, cleansers, disinfectants, ozone, fuels, dry-cleaning fluids, industrial gases, pesticides, pest repellents, out gassing products of building materials, chemicals released by office supplies, such as correction fluids, carbon-less copy paper, thermal paper, adhesives, writing and marking implements, and biological contaminants emanating from mold, rotting biological matter, biofilms and HVAC contamination by such agents as living organisms or chemicals. A non-limiting list of chemical agents that may be sampled as excretion products or environmental contaminants is listed in Table 1.

The devices, methods and systems of the present technology may comprise the printed piezoelectric technology, described in PCT application PCT/US2021/059193, Filed on Nov. 12, 2021 which is incorporated by reference in its entirety.

In one embodiment, the devices, methods and systems of the present technology may be used to detect the occurrence, or predict the probability of subsequent occurrence of conjunctival irritation, nose and throat irritation, headache, migraine, liver damage, kidney damage, central nervous system (CNS) damage, loss of coordination, ataxia, nausea, allergic skin or airway reactions, dyspnea, decrease in cholinesterase activity, emesis, bladder or bowel leakage, flatulence, belching, esophageal reflux, external bleeding epistaxis, fatigue, dizziness, visual disorders, memory impairment, reaction time slowing, heat stroke, hyponatremia, ketosis, ketoacidosis, hypoxia, ulcerative colitis, Crohn's disease, asthma, COPD, pulmonary hypertension, septic shock, acidosis, hyperventilation, bacterial infection, fungal infection, yeast infection, parasitic infection, hyperkalemia, rhabdomyolysis, tobacco use, vaping, COVID infection, gangrene, MRSA infection and sympathetic nervous system activation.

In one embodiment, the devices, methods, and systems of the present technology may comprise vibroacoustic and electropotential sensors, haptic actuators and sweat volatizing devices.

The portion of the mask covering the eyes is coated with an anti-fogging layer. This layer may be applied to the inside surface, the outer surface, or both surfaces. In addition, the inner, outer or both eye covering surfaces may be treated with an oleophobic coating for ease of cleaning.

### Manufacturing

For rapid solution, prototype development and scaling product for the market, 3D printing with 2D screen-printing is the preferred choice. There are two avenues for consideration when 3D printing a clear object—the material, and its processing.

For embodiments where identification of timing and/or location of analyte detection is critical, the personal protective equipment may be packaged so that the sensors are not activated until the packaging is opened. Activation will differ by sensor, but can be one or a combination of: electrical circuit activation, environmental moisture trigger or catalyst introduction for analyte detection, or opening of a check valve for analyte capture chambers. Furthermore, such activation steps may also initiate a geotag beacon or other wireless transmission.

### Remote or Secondary Diagnostics

A non-limiting list of condition for which devices, methods and systems of the present technology are useful for sdhPHR data management, diagnosing, monitoring or treating include pregnancy or breastfeeding, tinnitus, chronic disease/infection of ENT region, ear deformation/ear surgery, degenerative or inflammatory diseases of the central nervous system, severe cognitive/neuropsychological impairment, severe pain syndrome or other severe organic diseases, epilepsy, (past or present) psychiatric disorders latent psychosis, neurological disorders, diabetic polyneuropathy, diabetic polyneuropathy, malignancies/cancer, cardiac insufficiency, arterial hypertension, heart attack/stroke, severe hepatic or renal insufficiency, diseases of the hemopoietic system, alcoholism, substance abuse, addictive personality disorder, medical history of severe allergic or toxic reactions, chronic treatment including with centrally acting medication (e.g. antipsychotics, antiepileptics, antidepressants, etc.), non-removable metal pieces (aneurysm clips, artificial limbs, etc.) or implanted electronic devices (pacemaker, osmotic or other implanted pumps, cochlear implants, etc.), claustrophobia, acute (respiratory) infection, physical uneasiness, aortic stenosis, mitral regurgitation. pulmonary hypertension, pulmonary arterial hypertension, systolic heart failure, cardiovascular diseases, coronary artery disease, hypertension, pulmonary, cardiovascular diseases, coronary artery disease, aortic valve stenosis, mitral valve insufficiency, vascular diseases, heart Failure, heart Diseases, coronary disease, myocardial ischemia, lung diseases, respiratory tract diseases, heart valve diseases, heart failure, congestive heart failure, congestive heart failure with preserved ejection fraction, ventricular outflow obstruction, artery stenosis, asymptomatic atherosclerosis, arteriosclerosis, arterial occlusive diseases, carotid atherosclerosis, blood volume measurement, spinal injury, carotid artery diseases, carotid artery stenosis, carotid disease, carotid stenosis, cerebrovascular disorders, cardiovascular diseases, endarterectomy, carotid endarterectomy, stent patency and lumen status, stroke, nervous system diseases, vascular diseases, animal health monitoring, animal husbandry, and companion animal health (e.g. cats, dogs, rodents, reptiles, large mammals, zoonotic disease tracking). Generally, additional conditions that may be diagnosed, monitored or treated include, but are not limited to infectious diseases, idiopathic pathological processes, bronchial disease, alveolar diseases, congestive obstructive pulmonary disease, respiratory hypersensitivity, immediate hypersensitivity, hypersensitivity, immune system disorders, connective tissue disorders, autoimmune diseases, lupus, asthma, undifferentiated connective tissue disease, tuberculosis, Lyme disease, mycobacterial infections, actinomycetal infections, MRSA infections, gram-positive bacterial infections, gram-negative bacterial infections, and fungal infections.

Furthermore, specific analytes or analyte combinations may be tested for such as those found in the comptox chemicals list provided by the Environmental Protection Agency (www.comptox.epa.gov).

Specifically known analytes of interest have been analyzed via mass spectrometer to understand the specific VOC concentration ranges including minimum, maximum, limit of detection, and upper bounds of testing units. Table 1 below displays the VOC concentration ranges as a reference which is to be understood to vary according to the model of mass spectrometer used.

Such analytes of interest can be evaluated based on published data and in new clinical evaluations to obtain associations between certain VOCs and certain diseases such as lung cancer, thereby deriving and confirming the replicability and validity of certain For the unquantifiable compounds, calibration curves are not available. Analyses were conducted on presence/absence and log peaks. Several potentially predictive VOCs were identified for stage 1 lung cancer and their P-value and AUC from the test and training are shown in Table 2 below. With additional data points aggregated from the current invention's mask integrated sensors, the predictive training may be further refined.

TABLE 1
Quantifiable VOC Concentration Ranges of Analytes of Interest

| | | | Limit of | Upper |
|---|---|---|---|---|
| Compound | Minimum | Maximum | Detection | Bound |
| 2-Butanone | 0.00922 | 0.13602 | 0.00815 | 0.40000 |
| 2-Hexanol | 0.00219 | 0.08200 | 0.00199 | 0.00312 |
| 2-Pentanone | 0.00133 | 0.22125 | 0.00130 | 0.10000 |
| 3-Methyl-1- | 0.00184 | 0.04532 | 0.00181 | 0.05000 |
| Butanol | | | | |
| 3,3-dimethyl | 0.00157 | 0.00827 | 0.00124 | 0.10000 |
| pentane | | | | |
| Acetoin | 0.00059 | 17.49725 | 0.00037 | 4.00000 |
| Cyclohexanone | 0.00593 | 0.21534 | 0.00581 | 0.10000 |
| Dodecane | 0.00031 | 0.08950 | 0.00002 | 0.02500 |
| Ethylbenzene | 0.00082 | 0.00158 | 0.00074 | 0.05000 |
| Heptanal | 0.00028 | 0.13747 | 0.00023 | 0.02500 |
| Hexanal | 0.00335 | 0.02539 | 0.00334 | 0.10000 |
| p-Cymene | 0.00011 | 0.01693 | 0.00011 | 0.05000 |
| Toluene | 0.01864 | 0.03048 | 0.01854 | 0.20000 |

TABLE 2
Prediction Performance of Stage 1 Lung Cancer cases: p-values
and AUCs for presence/absence of unquantifiable VOCs.

| | P-value | | AUC | |
|---|---|---|---|---|
| Compound | Test | Training | Test | Training |
| Argon | 0.782 | 0.032 | 0.509 | 0.607 |
| Cyclopropane, | 0.313 | 0.082 | 0.544 | 0.599 |
| ethylidene- | | | | |
| Isopropyl Alcohol | 0.025 | 0.117 | 0.596 | 0.585 |
| Carbon dioxide | 0.237 | 0.356 | 0.552 | 0.562 |
| Acetone | 0.171 | 0.342 | 0.563 | 0.553 |
| Ethanol | 0.310 | 0.418 | 0.546 | 0.544 |
| Phosphonic acid, | 0.125 | 0.432 | 0.570 | 0.542 |
| (p-hydroxyphenyl)- | | | | |
| Cyclohexanol, | 0.273 | 0.291 | 0.517 | 0.539 |
| 1-methyl-4-(1-methylethyl)- | | | | |

### Configurations of the Present Technology

In certain embodiments, the mask of the present technology has a form factor as shown in FIGS. 1-11. It will clear to the person skilled in the art that the mask may comprise any combination of eye covering, nose covering and face covering components according to a desired use.

In certain other embodiments or aspects, the device may have a different form factor or uses whilst maintaining functional aspects such as modularity:
a drug delivery (with or without medication);
Devices for the ear such as a hearing aid, earphones, earbuds, headphones, ear covering shields.
Devices for the eyes such as goggles, spectacles, monocles, safety spectacles, sun glasses, visors (e.g. for sports, safety, military) or other eye wear.
Devices for the head such as a helmet such as a military, safety/protective or sports helmet; hat; headband.
Devices for the mouth such as mouthguards, self-contained breathing apparatus (SCBA).
Devices for the face, such as masks or visors for surgical, sport, or other protective use; ski masks; swimming goggles.
Devices for the wrist or arm such as smart watches, watches, connected bracelets, wearable activity trackers.
Clothing such as for protection against accidents and against fire; body armor; footwear such as boots, shoes, trainers; vests, hijabs, niqabs, abayas, mittens, gloves; uniforms such as for sport or military.
Supports such as knee, wrist, elbow, hip and shoulder pads for athletic or medical use; shin guards.
Devices for invasive use such as a cervical collar.
Collars for animals.

### BRIEF DESCRIPTION OF THE DRAWINGS

FIG. 1A shows a transparent personal protective equipment mask.

FIG. 1B shows a personal protective equipment mask with a flat transparent front and a non-transparent filter material on the perpendicular side surface so that the wearer's full unobstructed face may be viewed from directly in front.

FIG. 2 shows another possible embodiment of the mask incorporating glasses or sunglasses and integrated a support connected to both the glasses and mask body and configured to support the mask on a face of the subject.

FIG. 3 shows an embodiment of a face shield, filter mask, and glasses integrated together.

FIG. 4 shows an embodiment where the face shield and face mask integrated together.

FIG. 5 shows two views of the shapes that may comprised by the 3D printed metamaterials.

FIG. 6 shows an embodiment face shield and filter mask integrated together.

FIG. 7 shows a different placement for a modular sensor or communication coil

FIG. 8 shows an embodiment of glasses.

FIG. 9 shows an embodiment of glasses.

FIG. 10 shows an embodiment of glasses.

FIG. 11 shows the interface region of the mask to the subject's face.

FIG. 12 shows a graph of a variety of analytes based on wavelength and intensity.

FIG. 13 shows a graph of a variety of analytes based on wavelength and absorption.

FIG. 14 shows waveform capnography of various conditions of breathing.

FIG. 15 shows a standard inhalation and exhalation cycle.

FIG. 16 shows a diagram of the airflow during exhale with a breath analyte collection chamber integrated into the personal protective mask equipment.

FIG. 17 shows a diagram of the airflow during inhale with a breath analyte collection chamber integrated into the personal protective mask equipment.

FIG. 18 shows a diagram of the airflow during inhale with an environmental analyte collection chamber integrated into the personal protective mask equipment.

FIG. 19 shows a diagram of the airflow during exhale with an environmental analyte collection chamber integrated into the personal protective mask equipment.

### DETAILED DESCRIPTION

In general, embodiments of the present invention relate to personal protective equipment.

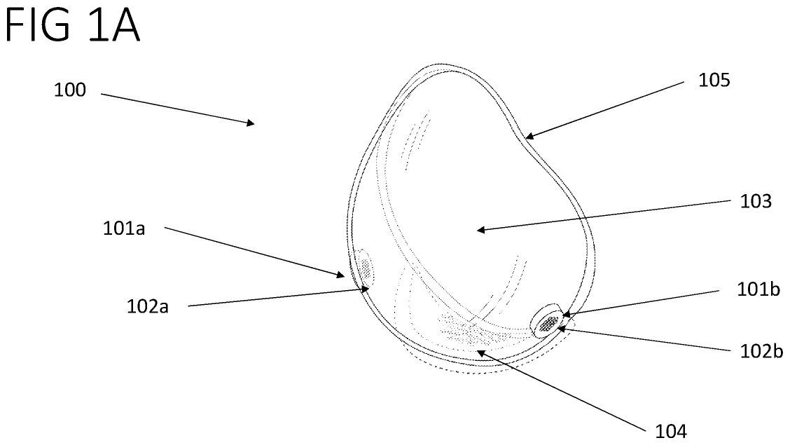

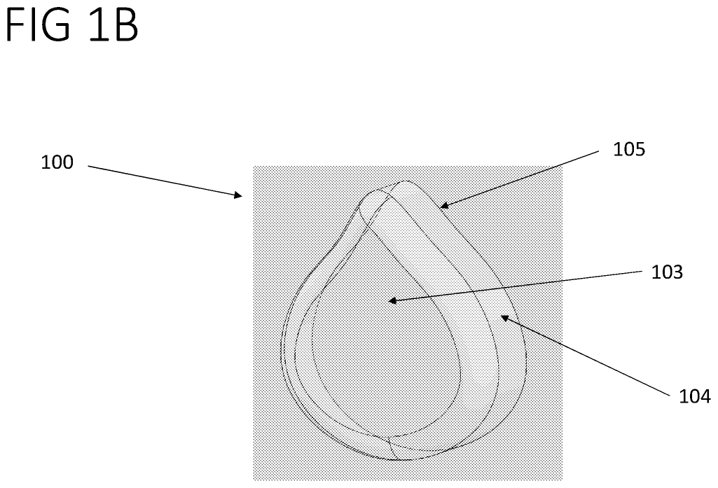

An exemplary mask 100 with module integrated sensors (101a and 101b) is shown in FIG. 1A. In this embodiment, the mask has two separate ports (102a and 102b) into which a sensor, analyte capture chamber, communication array/battery, or other equipment may be integrated. Each port may hold a multi-sensor array to save on space and weight. The front portion 103 of the mask is ideally made of a transparent material to allow the subject's facial expressions to be seen. However, in a minimalistic embodiment, the mask may be a melt-blown filter material that is not transparent. In this embodiment in which the front portion 103 is transparent, a conventional filter 104 is integrated near the chin and does not obstruct view of the face of the subject. The interface portion between the subject's face and the mask is preferably a flexible, well sealing material such as medical grade contoured silicone that stretches and compresses to create a good sealing perimeter 105 of the mask.

FIG. 1B. shows a mask embodiment 100 that emphasizes maintaining a transparent front 103 so that the subject's full unobstructed face may be viewed from directly in front. The interface portion between the subject's face and the mask is preferably a flexible, well sealing material such as medical grade contoured silicone that stretches and compresses to create a good sealing perimeter 105 of the mask. The circumferential perimeter edge seal 105 that contacts the face around the nose and mouth is maintained and flexibly moves when the user is talking or showing facial expressions. The mask surface perpendicular to the subject's face may be a melt blown filter material 104 that is not transparent as the perpendicular area minimally obstructs the face. The filter material 104 extends a large portion of the perimeter, thereby creating a large surface area to allow for sufficient air exchange during normal breathing. The front of the mask 103 is made of a transparent material such as acrylonitrile butadine styrene (ABS) or polysmooth filament which is durable and light weight. The transparent surface is ideally treated to minimize fogging and condensation, thereby allowing full view of the subject's face. Additional surface treatments such as scratch resistance, anti-glare, etc. may also be applied. The integrated sensors (not shown) and separate ports (not shown) into which a sensor, analyte capture chamber, communication array/battery, or other equipment may be integrated are ideally placed on the perpendicular areas to minimally obstruct the face The mask further has a support (not shown) connected to the mask body and configured to support the mask on a face of the subject. The support may be in the form of ear loops, a strap, band, clip, headband, or other material to secure the face mask to the subject's face.

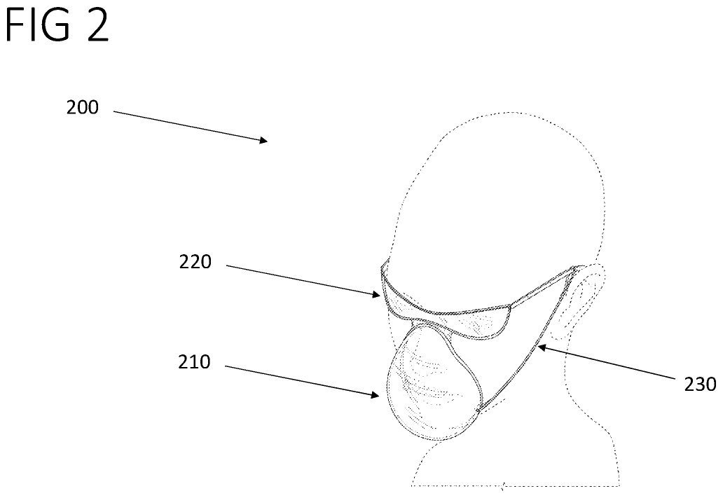

FIG. 2 shows an embodiment integrating a filter mask 210, and glasses 220 together. In this embodiment, all materials on the front of the face are ideally transparent. The non-transparent filter portion is integrated near the chin as shown in further detail in FIG. 1A, thereby allowing adequate surface area for filtered air exchange. Also shown are two ports into which a sensor, analyte capture chamber, communication array/battery, or other equipment may be integrated as shown in FIG. 1A. In this embodiment, the support 240 is a glasses frame and adjustable strap used to secure the mask onto the face.

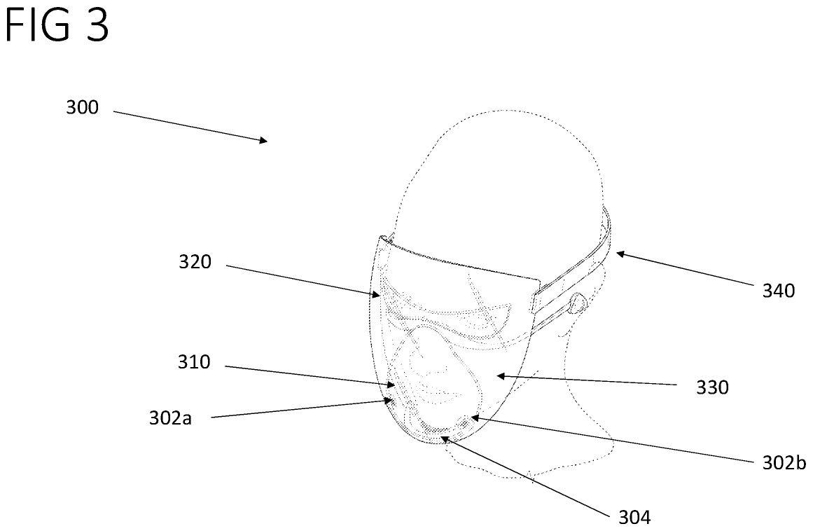

FIG. 3 shows an embodiment integrating a face shield 330, filter mask 310, and glasses 320 together. In this embodiment, all materials on the front of the face are ideally transparent. The non-transparent filter portion is integrated near the chin 304, thereby allowing adequate surface area for filtered air exchange. Also shown are two ports (302a and 302b) into which a sensor, analyte capture chamber, communication array/battery, or other equipment may be integrated.

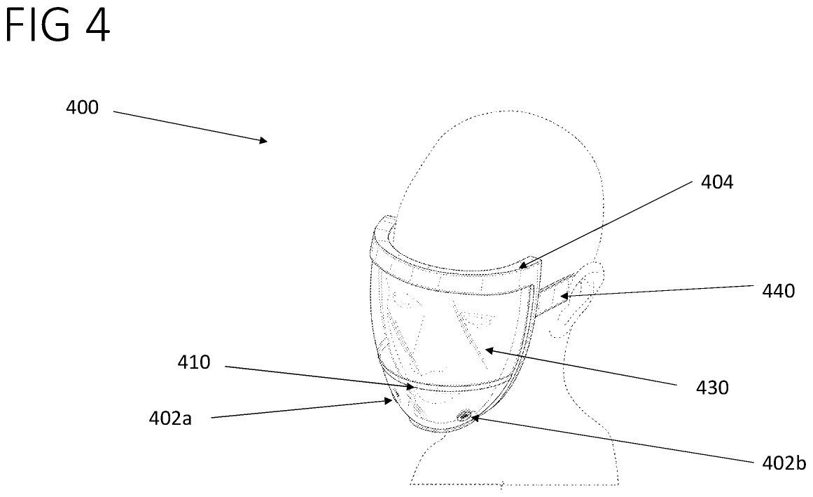

FIG. 4 shows an embodiment where the face shield 430 and face mask 410 are integrated together. The non-transparent filter portion 404 is integrated near the sealing circumferential perimeter edge which is expanded to above the eye brows, the sides of the face and under the chin, thereby allowing adequate surface area for filtered air exchange. Also shown are ports into which a sensor, analyte capture chamber, communication array/battery, or other equipment may be integrated. In this embodiment, the support is a head strap used to secure the mask onto the face.

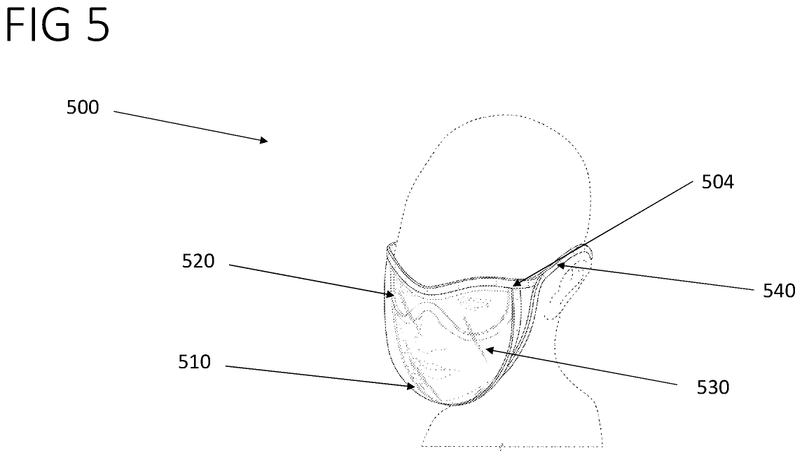

FIG. 5 shows an embodiment where the face shield 530, face mask 510, and glasses 520 are integrated together. The non-transparent filter portion 504 is integrated near the sealing circumferential perimeter edge which is expanded to above the eye brows, the sides of the face and under the chin, thereby allowing adequate surface area for filtered air exchange. In this embodiment, the support 540 are the frame legs of a pair of glasses that extend beyond the temple on each side of the head and taper down behind each ear. The tapering behind is ear is optionally flexible to allow for adjustment and securing the protective equipment onto the face. Much like a pair of glasses, the protective equipment is additionally secured onto the face via flexible material supported onto the bridge of the user's nose. In other embodiments, at least a portion of the face shield is transparent or translucent or at least a portion of the face shield comprises a photosensitive material. The nose and mouth covering may be integral thereto or the eye covering and/or the nose and mouth covering may be detachably attachable to the face shield.

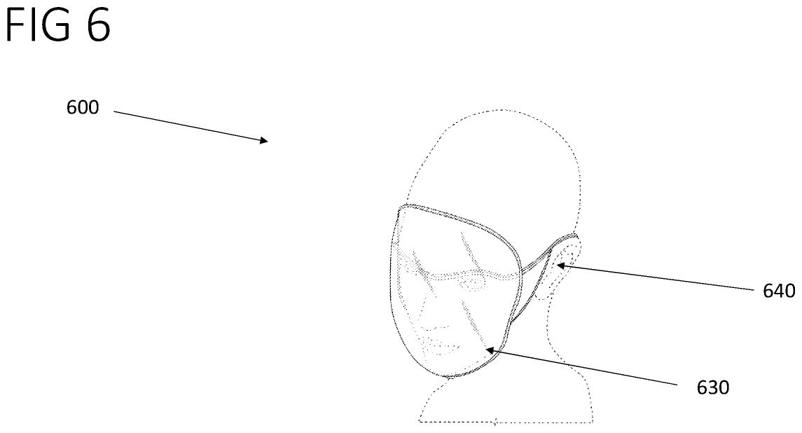

FIG. 6 shows an embodiment face shield 630 and filter mask are integrated together. An adjustable strap 640 secures the protective equipment onto face via adjustable ear loops.

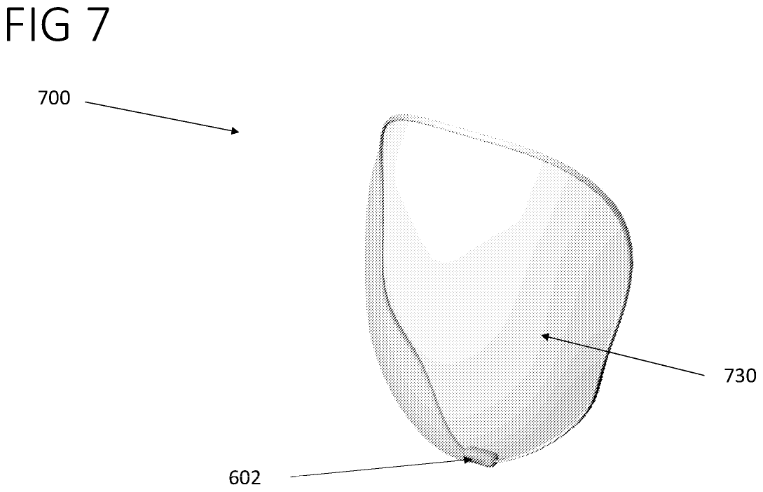

FIG. 7 shows a different placement for a modular sensor or communication coil near the chin within a port 702. Such distal placement by the chin may be protruding and have a secondary use as a handle portion to hold the mask 730 while putting on or removing the personal protective equipment.

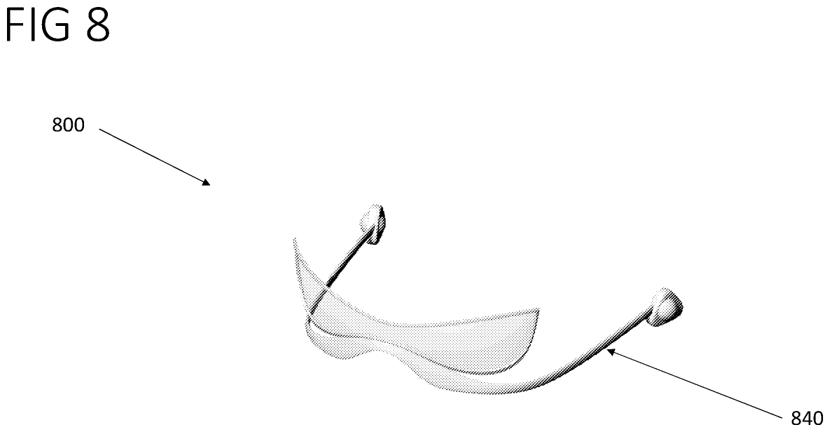

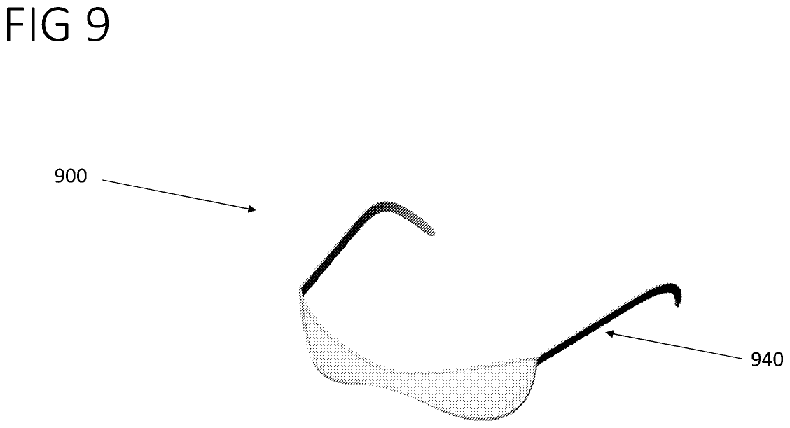

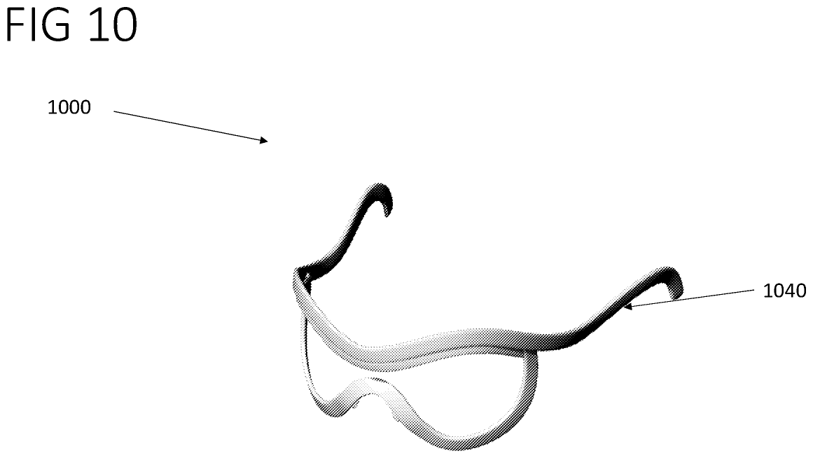

FIG. 8-10 shows a variety of embodiments of wearable glasses. In certain embodiments, the glasses are snuggly fitting around the eyes such as goggles or wraparound sun glasses. The lens portions may have shading, tinting, polarization, or be color doped to block certain wavelengths for certain uses.

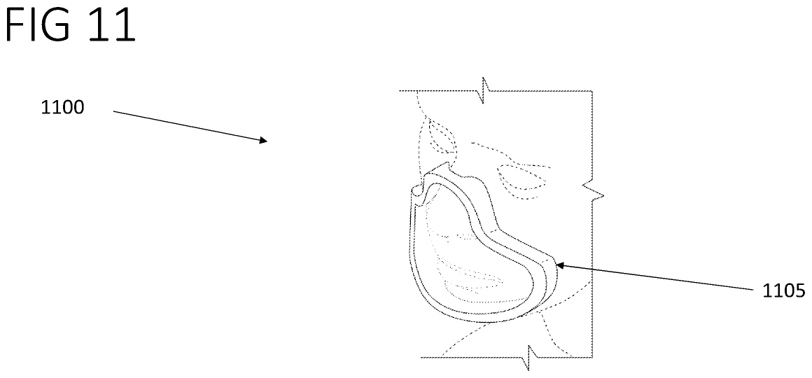

FIG. 11 shows the interface adaptor component 1105 of the mask that interfaces with the subject's face. By placing a large flexible monolithic piece of silicone or other flexible material, the seal on the face is maintained even when the user is speaking. This configuration further minimizes the errant non-filtered air flow that is commonly seen in disposable surgical masks that do not create a good seal around the nose and mouth.

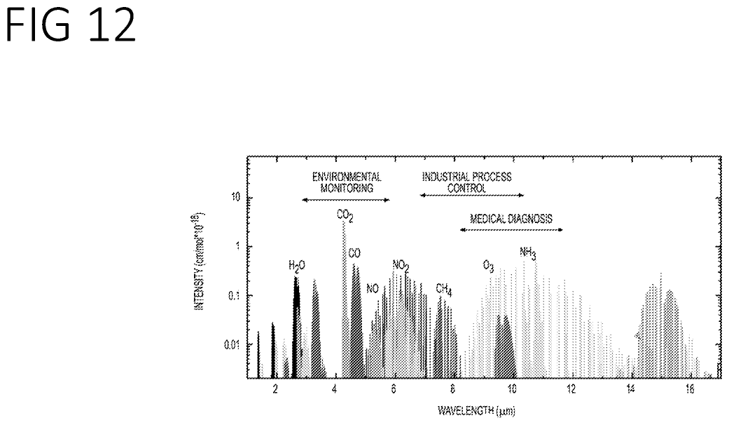

FIG. 12 shows a graph of a variety of analytes based on wavelength and intensity. Specifically, known gases such as CO₂, CO, NO₂, O₃, NH₃ have been identified and are quantifiable by detectable by their known wavelength peaks.

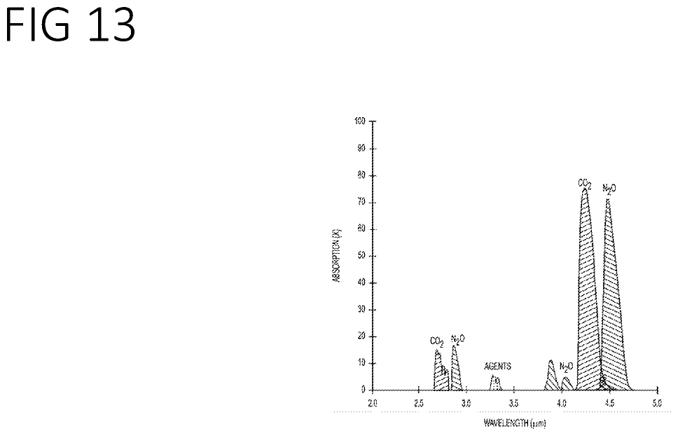

FIG. 13 shows a graph of a variety of analytes based on wavelength and absorption.

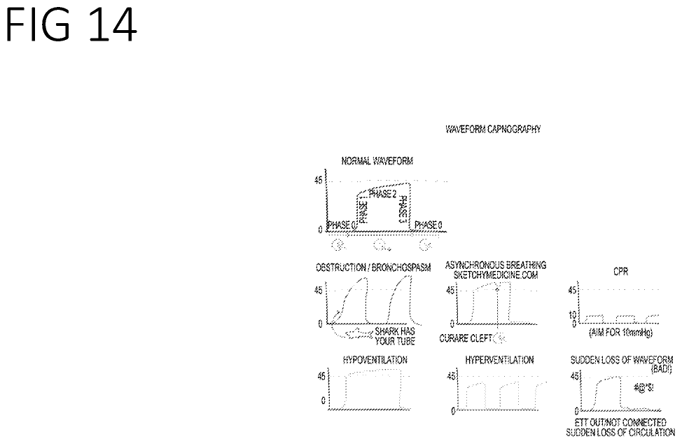

FIG. 14 shows waveform capnography of various conditions of breathing. The normal detectable peak threshold of CO₂ gas is 45% during exhalation. By monitoring the air flow and concentration of CO₂ gas percentage over a set time period, a specific non-normal breathing wave form can be identified.

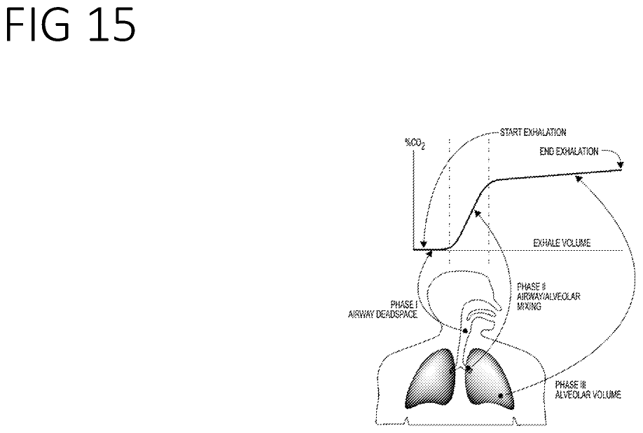

FIG. 15 shows a standard inhalation and exhalation cycle.

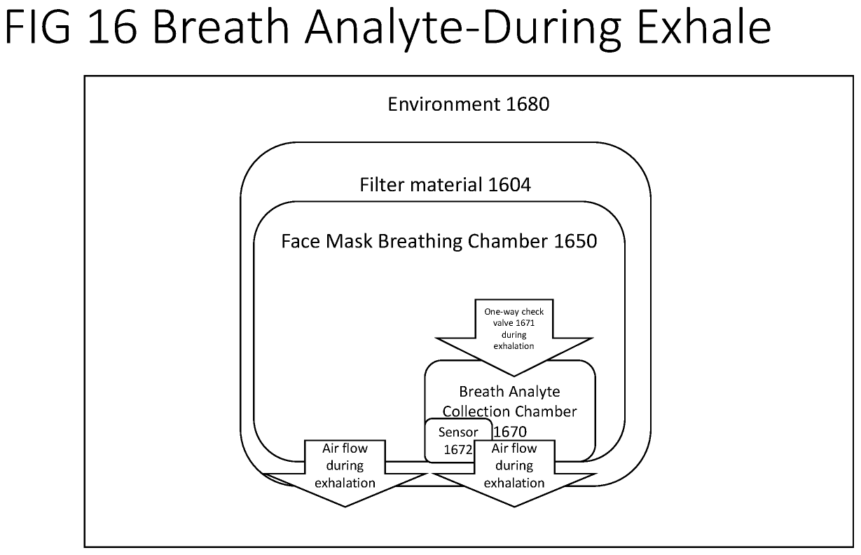

FIG. 16 shows a diagram of the airflow during exhale with a breath analyte collection chamber integrated into the personal protective mask equipment. An exhalation analyte capture mask 100 comprises a mask body that forms a breathing cavity sized to receive the nose and mouth of a subject, the mask body having a circumferential perimeter edge 105 that contacts the face around the nose and mouth, to form an enclosed face mask breathing chamber 1650. During exhale, air from the subject's lungs travels out of the nose and mouth to the breathing chamber 1650. From the breathing chamber 1650, a portion of the exhale is filtered through the filter material 1604 to the environment 1680. Some portion of the exhale travels through a one-way check valve 1671 that is open only during exhale into the breath analyte collection chamber 1670. Breath analyte is retained in the breath analyte collection chamber 1670 while excess air if filtered out to the environment. Each exhale by the subject adds additional analyte into the collection chamber 1670. After multiple cycles of exhalation, target analytes will aggregate, making it easier to detect or sample. In certain embodiments, the capture chamber 1670 contains one or more sensors 1672 to allow for instant detection, analysis, or confirmation of the presence of a target analyte. Such information can be conveyed to the subject via one or more colorimetric indicators that change color once a target analyte is detected or a detection threshold volume of the target analyte is collected within the capture chamber. For privacy, the colorimetric indicators are ideally placed on the inside portion of the port (see FIG. 1) so that it is only visible by the user once the mask is removed in a safe environment.

In some embodiments the mask further comprises a wireless communication module facilitating wireless data exchange between the mask and an external device for obtaining sensor data from sensors contained within the capture chamber and transmitting the obtained sensor data to the external device, wherein the sensor data comprises at least one of a time of analyte detection, a geolocation of the sensor at time of analyte detection. The wireless communication module can be modularly placed in one of the ports, or onto the peripheral region of the mask as to not obstruct the transparent front area. Such information is vital in understanding the specific situations which trigger increases in certain analytes and may be correlated with information obtained from other sensors by time stamp overlapping.

In some embodiments, it is preferable that the analyte capture chamber is detachable from the mask body as to allow for extraction of captured analyte for testing. The analyte capture chamber may be sent to a central lab in which more conventional lab testing (e.g. mass spectrometer, reverse transcription polymerase chain reaction (RT-PCR), spectroscopic testing, etc.) can be completed. In these use cases, the analyte capture chamber preferably contains room-temperature virus and/or bacterial transport culture mediums to prevent or slow the denaturing of the target analyte until testing in a central lab. A variety of specimen transport reagents are available by various manufacturers including: Sigma molecular transport medium (MM; Medical Wire), eNAT (Copan), Primestore molecular transport medium (MTM; Longhorn Vaccines and Diagnostics), Cobas PCR medium (Roche), Aptima specimen transport medium (Hologic), DNA/RNA Shield (Zymo Research), guanidine hydrochloride (GCHI) and guanidine thiocyanate (GITC) buffers containing Triton X-100 (both, Oxoid/Thermo Fisher), and virus transport and preservation medium (inactivated) (BioComma) to name a few. According to the target analyte, the analyte capture chamber may contain an absorbant such as chalk, baking soda, or a binding agent to ensure capture and transport of the target analyte.

If the target analyte is a virus, a viral transport medium (VTM) would be used in the capture chamber. A room temperature stable VTM formulation includes a combination of: Hank's balanced salt solution, bovine serum albumin, L-cysteine, gelatin, sucrose, L-glutamic acid, HEPES buffer, vancomycin, amphotericin B, colistin, phenol red. If the target analyte is a microorganism such as bacteria, a bacterial transport medium (BTM) would be used in the capture chamber. Common BTMs include carbohydrates, peptones, and other nutrients (excluding growth factors) designed to preserve the viability of bacterial during transport without allowing the bacteria to multiply. Preferably, both the VTM or BTM contains one or more mechanisms to inactivate the virus or bacteria while preserving and stabilizing labile DNA and RNA for downstream molecular testing.

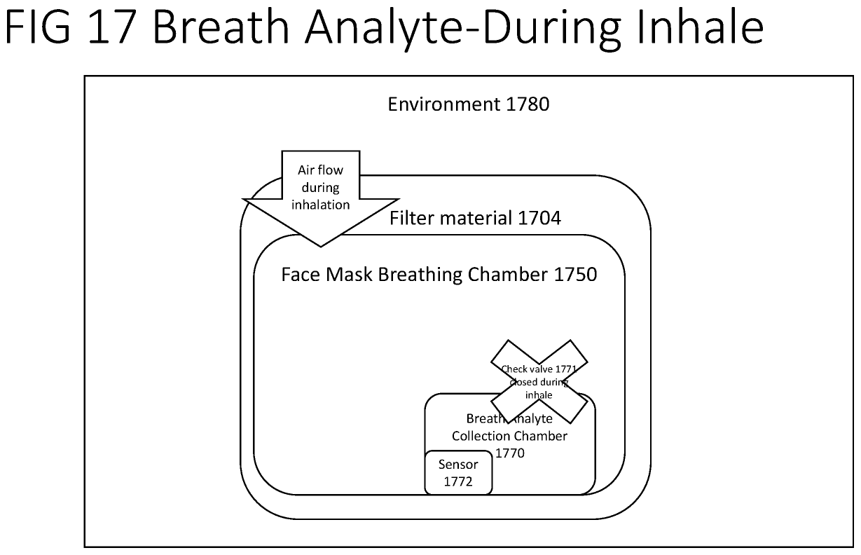

FIG. 17 shows a diagram of the airflow during inhale with a breath analyte collection chamber 1750 integrated into the personal protective mask equipment. During inhale the air flows from the environment 1780, through the filter material 1704, and into the face mask breathing chamber 1750. From the face mask breathing chamber 1750, the filtered air can travel through the nose or mouth and into the lungs. During the inhale process, the one-way check valve 1771 on the breath analyte collection chamber 1770 is closed, therefore there is no air flow movement from or to the breath analyte collection chamber 1770.

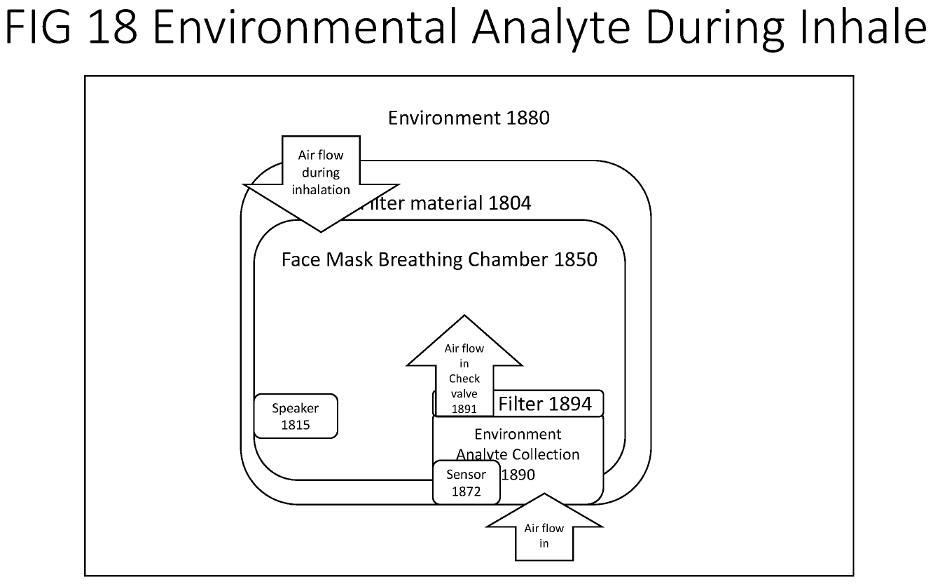

FIG. 18 shows a diagram of the airflow during inhale with an environmental analyte collection chamber 1890 integrated into the personal protective mask equipment. During inhale the air flows from the environment, through the filter material 1804, and into the face mask breathing chamber 1850. From the face mask breathing chamber 1850, the filtered air can travel through the nose or mouth and into the lungs. During the inhale process, the one-way check valve 1891 on the environmental analyte collection chamber 1890 is open, therefore air travels in from the environment, unfiltered into the environmental analyte collection chamber where the analyte is collected. The air is then filtered through a filter 1894 prior to entering the face mask breathing chamber. Each inhale by the subject adds additional analyte into the collection chamber. After multiple cycles of inhalation, target analytes will aggregate, making it easier to detect or sample. In certain embodiments, the collection chamber contains one or more sensors 1872 to allow for instant detection, analysis, or confirmation of the presence of a target analyte. For certain hazardous analytes, a sound may be played via a speaker 1815 alerting the user to move to a different environment.

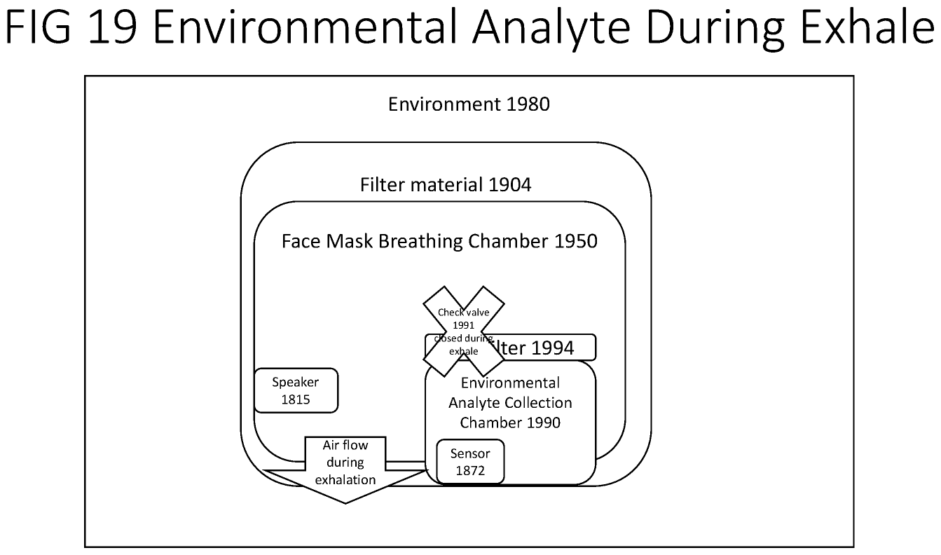

FIG. 19 shows a diagram of the airflow during exhale with an environmental analyte collection chamber 1990 integrated into the personal protective mask equipment. During exhale, air from the subject's lungs travels out of the nose and mouth to the breathing chamber 1950. From the breathing chamber 1950, the exhale is filtered through the filter material 1904 to the environment 1980. The one-way check valve 1991 is closed during exhale and no exhale enters the environmental analyte collection chamber 1990.

In yet another embodiment, the analyte detection is completed in real-time. The analyte detection mask comprises: a) a mask body that forms a breathing cavity sized to receive the nose and mouth of a subject, the mask body having a circumferential perimeter edge that contacts the face around the nose and mouth, to form an enclosed breathing area, b) a filter material portion integrated into at least a part of the mask body, wherein the filter material portion provides a surface area of the mask body through which air may flow in and out of during inhalation and exhalation by the subject c) at least one breathing passage configured to allow the subject's inhaled or exhaled air flow into therethrough, d) an optical path transecting across said breathing passage permitting the transmission of a signal therethrough; and e) a support connected to the mask body and configured to secure the mask on a face of the subject. The signal transecting across the breathing passage is a pulsed radiation to test absorption of one or more analytes in the inhaled or exhaled air. In one embodiment, the radiation is generated by an LED emitting an approximately 4.2 micron wavelength and of a bandwidth encompassing the absorption band of CO₂ in said optical path and a detector for pulsed radiation is positioned adjacent said breathing passage for the receipt of radiation emitted by said LED source. Detected readings are used to provide a pulsed waveform output in response to the received pulsed radiation from said LED source for the CO₂. Processing electronics electrically connected to said detector, said processing electronics responsive to the pulsed waveform output provided by said detector and generating an output capnogram representation of the concentration of CO₂ in said breathing passage. In other embodiments, the analyte detection mask also contains a window and a reflector to further optimize the signal pathway of detection. The analyte detection mask may optimally further comprise a heater for maintaining an ideal temperature for the detector to limit error of the capnogram and to actively remove any condensation which may skew the data obtained.

### REFERENCES

1. Jordan R E, Adab P, Cheng K K. COVID-19: Risk factors for severe disease and death. BMJ 2020 m1198. doi: 10.1136/bmj.m1198
2. Cacioppo J T, Hawkley L C, Norman G J et al. Social isolation. Ann NY Acad Sci 2011; 1231 (1): 17. doi: 10.1111/j.1749-6632.2011.06028.x
3. Baumeister R F, Twenge J M, Nuss C K. (2002). Effects of social exclusion on cognitive processes: Anticipated aloneness reduces intelligent thought. J Pers Soc Psychol. 2002; 83 (4): 817. doi: 10.1037/0022-3514.83.4.817
4. Seeman T E. Health promoting effects of friends and family on health outcomes in older adults. Am J Health Promo.2000; 14 (6): 362. doi: 10.4278/0890-1171-14.6.362
5. Cacioppo J T, Hawkley L C. Social isolation and health, with an emphasis on underlying mechanisms. Perspect BiolMed. 2003; 46 (3): S39-S52. doi;10.1353/pbm.2003.0049

### Incorporations by Reference

Additional metrics and sensors are described in U.S. Ser. No. 17/096,806 filed Nov. 12, 2020, the contents of which are incorporated herein by reference in their entirety. Use of biometric data is further described in U.S. 63/075,059 filed Sep. 4, 2020, the contents of which are incorporated herein by reference in their entirety. Embodiments of the present mask may incorporate further components such as one or more of those described or illustrated in U.S. 63/124,593 filed Dec. 11, 2020 entitled “Wearable for condition-based monitoring and health failure prediction” and PCT application claiming priority therefrom and bearing attorney reference 106964/64 and filed Dec. 13, 2021, the contents of which are incorporated herein in their entirety.

1. A mask for a subject, the mask comprising:
a nose and mouth covering sized and shaped to cover the nose and mouth of the subject in use, the nose and mouth covering including a filter portion permitting air flow therethrough;
a sensor module connected to the nose and mouth covering and including at least one breath sensor for detecting one or more parameters related to an inhalation and/or an exhalation of the subject; and
a support member configured to support the mask on the face of the subject.

2-6. (canceled)

7. The mask of claim 1, wherein the at least one breath sensor is configured to detect one or more of an air flow, respiration rate, an air composition, a carbon dioxide content, an oxygen content, a volatile organic compound, a water content, an audible and inaudible sound quality, and a temperature of the inhalation and/or the exhalation, wherein the sensor module further comprises at least one physiological sensor for detecting one or more parameters relating to a body of the subject wearing the mask, the one or more parameters not being related to the inhalation and/or the exhalation of the subject.

8. (canceled)

9. The mask of claim 7, wherein the at least one physiological sensor is configured to detect one or more of an electric potential signal, a vibroacoustic signal, a temperature, a galvanic skin response, a hydration state, blood volume changes through photoplethysmography and a body fat content of the subject.

10. (canceled)

11. The mask of claim 1, further comprising an environmental sensor, wherein the at least one environmental sensor is configured to detect one or more of: an orientation of the mask, a temperature of the environment, a humidity of the environment, a pressure of the environment, light of the environment, sound of the environment, and air quality of the environment.

12-13. (canceled)

14. The mask of claim 1, wherein the breath sensor in the sensor module is communicatively coupled to a processor of a computer system.

15-16. (canceled)

17. The mask of claim 1, further comprising a removable capture chamber for capturing inhaled or exhaled air from the subject in use, the capture chamber including a one-way valve for maintaining the inhaled or the exhaled air therein.

18-23. (canceled)

24. An exhalation analyte capture mask comprising:
a mask body that forms a breathing cavity sized to receive the nose and mouth of a subject, the mask body having a circumferential perimeter edge that contacts the face around the nose and mouth, to form an enclosed breathing area;
a filter material portion integrated into at least a part of the mask body, wherein the filter material portion provides a surface area of the mask body through which air may flow in and out of during inhalation and exhalation by the subject;
at least one capture chamber connected to the mask body by a one-way check valve and configured to allow the subject's exhaled air flow into the capture chamber; and
a support connected to the mask body and configured to secure the mask on a face of the subject.

25. The exhalation analyte capture mask of claim 24, wherein the capture chamber further comprises a filter material portion to allow for air flow out of the capture chamber while retaining any target analyte within, thereby capturing and retaining the target analyte within the capture chamber.

26. The exhalation analyte capture mask of claim 24, wherein the capture chamber contains one or more sensors.

27. The exhalation analyte capture mask of claim 24, wherein the capture chamber contains one or more colorimetric indicators that change color once a target analyte is detected or a detection threshold volume of the target analyte is collected within the capture chamber.

28. The exhalation analyte capture mask of claim 26, wherein the mask further comprises a wireless communication module facilitating wireless data exchange between the mask and an external device for obtaining sensor data from the one or more sensors contained within the capture chamber and transmitting the obtained sensor data to the external device, wherein the sensor data comprises at least one of a time of analyte detection, a geolocation of the sensor at time of analyte detection.

29. The exhalation analyte capture mask of claim 24, wherein the capture chamber is detachable from the mask body as to allow for extraction of captured analyte for testing.

30. The exhalation analyte capture mask of claim 24, wherein the capture chamber contains transport culture mediums to prevent or slow the denaturing of the target analyte.

31. (canceled)

32. A method for monitoring a condition of a subject, the method executable by a processor of a computer system, the method comprising:
receiving data from the at least one breath sensor integrated in a mask worn by a subject; and
applying a trained machine learning algorithm to determine a condition of the subject.

33. The method of claim 32, further comprising receiving a secondary data set from at least one secondary sensor worn by the subject that is not the at least one sensor integrated in a mask worn by the subject.

34. The method of claim 33, wherein the secondary data is derived from an environmental sensor worn by the subject.

35. The method of claim 32, further comprising receiving a secondary data set from a second subject's breath sensor integrated in a mask worn by a second subject.

36-42. (canceled)

43. The method of claim 32, further comprising receiving a secondary data set from a second subject's environmental sensor.

44. The method of claim 32, wherein the processor is configured to determine from the received one or more signal data whether an anomalous event has occurred in an environment and cause an alert to be sent to one or more users from which signal data was received.

45. The mask of claim 1, further comprising:
at least one breathing passage configured to allow the subject's inhaled or exhaled air flow into therethrough;
an optical path transecting across said breathing passage permitting the transmission of a signal therethrough, wherein the signal transecting across the breathing passage is a pulsed radiation to test absorption of one or more analytes in the inhaled or exhaled air; and
a support connected to the mask body and configured to secure the mask on a face of the subject.
